(19) United States
(12) Patent Application Publication
(10) Pub. No.: US 2023/0223040 A1
(43) Pub. Date: Jul. 13, 2023

(54) VOICE ACTIVITY DETECTION APPARATUS, LEARNING APPARATUS, AND STORAGE MEDIUM

(71) Applicant: KABUSHIKI KAISHA TOSHIBA, Tokyo (JP)

(72) Inventor: Uihyun KIM, Kawasaki (JP)

(73) Assignee: KABUSHIKI KAISHA TOSHIBA, Tokyo (JP)

(21) Appl. No.: 17/894,110

(22) Filed: Aug. 23, 2022

(30) Foreign Application Priority Data
Jan. 7, 2022 (JP) 2022-001940

(51) Int. Cl. G10L 25/78; G10L 15/08

(52) U.S. Cl. CPC G10L 25/78; G10L 15/08

(57) ABSTRACT

According to one embodiment, a voice activity detection apparatus includes a processing circuit. The processing circuit acquires an acoustic signal and a non-acoustic signal relating to a same source, calculates an acoustic feature based on the acoustic signal, calculates a non-acoustic feature based on the non-acoustic signal, calculates a reliability weight based on a difference between the acoustic signal and the non-acoustic signal, calculates an integrated feature of the acoustic feature and the non-acoustic feature based on the reliability weight, calculates a voice existence probability based on the integrated feature, and detects a voice section and/or a non-voice section based on comparison of the voice existence probability with a threshold.

### CROSS-REFERENCE TO RELATED APPLICATION(S)

This application is based upon and claims the benefit of priority from prior Japanese Patent Application No. 2022-001940, filed, Jan. 7, 2022, the entire contents of which are incorporated herein by reference.

### FIELD

Embodiments described herein relate generally to a voice activity detection apparatus, a learning apparatus, and a storage medium.

### BACKGROUND

Voice activity detection (VAD) is a technique of detecting a voice section including the user's voice from an input signal. Voice activity detection is mainly used for improving recognition accuracy of voice recognition, and/or used for supporting data compression in a non-voice section in the field of voice encoding.

Voice activity detection requires processing of detecting a voice section including predetermined voice from a time section of an input signal. For example, for determining whether the processing target frame is a voice (for example, speech) section or not, the voice section is detected from the input acoustic signal using a model trained in advance.

To further enhance processing accuracy of voice activation detection in an environment in which processing is difficult, such as a noise environment, a voice activity detection apparatus has been presented. The voice activity detection apparatus detects a voice section using both an acoustic signal and a non-acoustic signal, such as a lip image signal, as an input signal. For example, a technique disclosed in Patent Literature 1 (Japanese Patent Application Publication No. 2011-191423) calculates an utterance probability and detecting a voice section, based on a Bayesian network using a feature quantity of acoustic information extracted from an acoustic voice collection apparatus and a visual feature quantity relating to the lengths in the horizontal direction and the vertical direction of the lips in a lip area extracted from an image pickup unit.

### BRIEF DESCRIPTION OF THE DRAWINGS

FIG. 1 is a diagram illustrating a configuration example of a voice activity detection apparatus.

FIG. 2 is a diagram illustrating an example of flow of voice activity detection processing.

FIG. 3 is a diagram schematically illustrating the voice activity detection processing.

FIG. 4 is a diagram illustrating an example of an input signal (video signal), an acoustic signal, and an image signal.

FIG. 5 is a diagram illustrating a configuration example of a learning apparatus.

FIG. 6 is a diagram illustrating an example of flow of learning processing.

FIG. 7 is a configuration example of an integrated neural network.

FIG. 8 is a diagram illustrating an example of an image signal (image data) according to an example.

FIG. 9 is a table illustrating verification results under matched noise conditions using a data set of CHiME4.

FIG. 10 is a table illustrating verification results under mismatched noise conditions using a data set of EastAnglia.

FIG. 11 is a diagram illustrating mean ROC curves of an Audio-only model and baseline models under matched noise conditions.

FIG. 12 is a diagram illustrating a configuration example of a voice activity detection apparatus according to an additional example.

FIG. 13 is a diagram illustrating an example of flow of voice activity detection processing according to the additional example.

FIG. 14 is a diagram schematically illustrating learning processing according to the additional example.

### DETAILED DESCRIPTION

According to one embodiment, a voice activity detection apparatus includes a processing circuit. The processing circuit acquires an acoustic signal and a non-acoustic signal relating to a same voice generation source. The processing circuit calculates an acoustic feature based on the acoustic signal. The processing circuit calculates a non-acoustic feature based on the non-acoustic signal. The processing circuit calculates a reliability weight based on a difference between the acoustic signal and the non-acoustic signal. The processing circuit calculates an integrated feature of the acoustic feature and the non-acoustic feature based on the reliability weight. The processing circuit calculates a voice existence probability based on the integrated feature. The processing circuit detects a voice section and/or a non-voice section based on comparison of the voice existence probability with a threshold. The voice section is a time section in which voice is presence. The non-voice section is a time section in which voice is absence.

The technique of Patent Literature 1 is based on the premise that a normal lip image signal is an input signal, and has the problem that accuracy of voice activity detection largely decreases due to abnormal image input caused by, for example, the speaker's wearing a mask, the speaker's face turning sideways, failure in estimation of a mouth region, and/or an error in reading moving images in actual processing.

Specifically, the technique disclosed in Patent Literature 1 is calculation of the conditional probability using the acoustic feature quantity and the visual feature quantity with respect to presence/absence of voice, and the detection accuracy thereof decreases due to the abnormal visual feature quantity calculated from the abnormal image input.

The problem to be solved by the present embodiment is to provide a voice activity detection apparatus, a learning apparatus, and a storage medium capable of reducing decrease in detection accuracy caused by abnormal image input.

The following is an explanation of a voice activity detection apparatus, a learning apparatus, and a storage medium according to the present embodiment with reference to drawings.

### Voice Activity Detection Apparatus

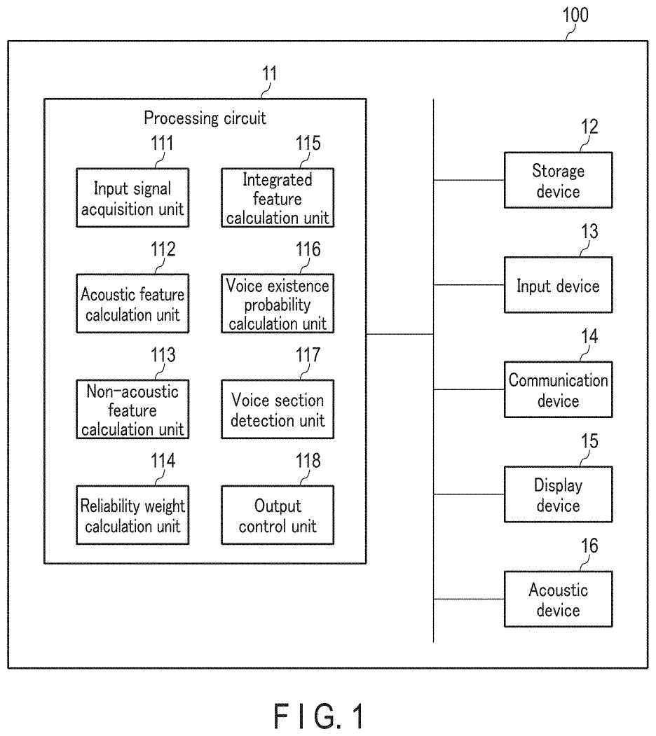

FIG. 1 is a diagram illustrating a configuration example of a voice activity detection apparatus 100. The voice activity detection apparatus 100 is a computer detecting a voice section of an input signal. As illustrated in FIG. 1, the voice activity detection apparatus 100 includes a processing circuit 11, a storage device 12, an input device 13, a communication device 14, a display device 15, and an acoustic device 16.

The processing circuit 11 includes a processor, such as a CPU (Central Processing Unit), and a memory, such as a RAM (Random Access Memory). The processing circuit 11 executes voice activity detection processing of detecting a voice section of the input signal, by executing a voice activity detection program stored in the storage device 12. The voice activity detection program is recorded on a non-transitory computer-readable storage medium. The processing circuit 11 achieves an input signal acquisition unit 111, an acoustic feature calculation unit 112, a non-acoustic feature calculation unit 113, a reliability weight calculation unit 114, an integrated feature calculation unit 115, a voice existence probability calculation unit 116, a voice section detection unit 117, and an output control unit 118, by reading and executing the voice activity detection program from the storage medium. The voice activity detection program may include a plurality of modules implemented with functions of the units 111 to 118 in a divided manner.

Hardware implementation of the processing circuit 11 is not limited to only the mode described above. For example, the processing circuit 11 may be formed of a circuit, such as an application specific integrated circuit (ASIC), achieving the input signal acquisition unit 111, the acoustic feature calculation unit 112, the non-acoustic feature calculation unit 113, the reliability weight calculation unit 114, the integrated feature calculation unit 115, the voice existence probability calculation unit 116, the voice section detection unit 117, and/or the output control unit 118. The input signal acquisition unit 111, the acoustic feature calculation unit 112, the non-acoustic feature calculation unit 113, the reliability weight calculation unit 114, the integrated feature calculation unit 115, the voice existence probability calculation unit 116, the voice section detection unit 117, and/or the output control unit 118 may be implemented in a single integrated circuit or individually implemented in a plurality of integrated circuits.

The input signal acquisition unit 111 acquires an acoustic signal and a non-acoustic signal relating to the same voice generation source. The acoustic signal and the non-acoustic signal are time-series signals, and are temporally synchronized in units of frame. The acoustic signal is a signal relating to voice uttered by a speaker serving as the voice generation source. The non-acoustic signal is a signal other than the acoustic signal relating to the speaker and collected substantially simultaneously with the acoustic signal. For example, the non-acoustic signal is an image signal relating to the uttering speaker, and/or a sensor signal relating to physiological response of lips and/or a face muscle and brain waves of the speaker generated by utterance.

The acoustic feature calculation unit 112 calculates a feature quantity (hereinafter referred to as “acoustic feature”) of the acoustic signal. The acoustic feature has a value based on the acoustic signal and a value correlated with voice uttered by the speaker. The acoustic feature is calculated for each of frames. As an example, the acoustic feature is calculated using a first trained model. The first trained model is a neural network trained to receive an acoustic signal and output an acoustic feature. The first trained model is stored in the storage device 12 or the like.

The non-acoustic feature calculation unit 113 calculates a feature quantity (hereinafter referred to as “non-acoustic feature”) of the non-acoustic signal. The non-acoustic feature has a value based on the non-acoustic signal and a feature value correlated with voice uttered by the speaker. The non-acoustic feature is calculated for each of frames. As an example, the non-acoustic feature is calculated using a second trained model. The second trained model is a neural network trained to receive a non-acoustic signal and output a non-acoustic feature. The second trained model is stored in the storage device 12 or the like.

Each of the first trained model and the second trained model is a neural network trained to provide a penalty for a difference between the acoustic feature and the non-acoustic feature relating to the same voice generation source.

The reliability weight calculation unit 114 calculates a reliability weight on the basis of a difference between the acoustic feature and the non-acoustic feature. The reliability weight is calculated for each of frames as a determination value to determine input of an abnormal non-acoustic signal. As an example, the reliability weight include a first reliability weight calculated as a value between an intermediate value and an upper limit value for the difference between the acoustic feature and the non-acoustic feature, and a second reliability weight calculated as a value acquired by subtracting the first reliability weight from the upper limit value. For example, in the case where each of the first reliability weight and the second reliability weight has a numerical range of 0 to 1, the intermediate value is preferably set to 0.5, and the upper limit value is preferably set to 1.

The integrated feature calculation unit 115 calculates an integrated feature of the acoustic feature and the non-acoustic feature on the basis of the reliability weight calculated with the reliability weight calculation unit 114. The integrated feature is calculated for each of frames. As an example, the integrated feature calculation unit 115 calculates an integrated feature of the acoustic feature corrected with the first reliability weight and the non-acoustic feature corrected with the second reliability weight.

The voice existence probability calculation unit 116 calculates a voice existence probability on the basis of the integrated feature. The voice existence probability is used as a scale to distinguish a voice section from a non-voice section. The voice section is a time section in which voice is uttered in the time sections of the input signal, and a non-voice section is a time section in which no voice is uttered in the time sections of the input signal. The voice existence probability is calculated for each of frames. As an example, the voice existence probability is calculated using a third trained model. The third trained model is a neural network trained to receive an integrated feature and output a voice existence probability. The neural network is a neural network trained to provide a penalty for a difference between a correct label relating to the voice section and the non-voice section and the voice existence probability. The third trained model is stored in the storage device 12 or the like.

The voice section detection unit 117 detects a voice section and/or a non-voice section based on a comparison of the voice existence probability with a threshold. The voice section is a time section in which voice is present. The non-voice section is a time section in which voice is absent.

The output control unit 118 displays various types of information via the display device 15 and/or the acoustic device 16. For example, the output control unit 118 displays an image signal on the display device 15 and/or outputs an acoustic signal via the acoustic device 16.

The storage device 12 is formed of, for example, a ROM (Read Only Memory), a HDD (Hard Disk Drive), a SSD (Solid State Drive), and/or an integrated circuit storage device. The storage device 12 stores therein various arithmetic calculation results acquired with the processing circuit 11 and/or the voice section detection program executed with the processing circuit 11 and the like. The storage device 12 is an example of a computer-readable storage medium.

The input device 13 inputs various commands from the user. Applicable examples of the input device 13 include a keyboard, a mouse, various types of switches, a touch pad, and a touch panel display. The output signal from the input device 13 is supplied to the processing circuit 11. The input device 13 may be a computer connected with the processing circuit 11 in a wired or wireless manner.

The communication device 14 is an interface to execute information communication with an external device connected with the voice activity detection apparatus 100 via a network. The communication device 14 receives an acoustic signal and a non-acoustic signal from, for example, a device collecting the acoustic signal and the non-acoustic signal, and/or receives the first trained model, the second trained model, and the third trained model from a learning apparatus described later.

The display device 15 displays various types of information. Applicable examples of the display device 15 include a CRT (Cathode-Ray Tube) display, a liquid crystal display, an organic EL (Electro Luminescence) display, a LED (Light-Emitting Diode) display, a plasma display, and any other displays known in the technical field. The display device 15 may be a projector.

The acoustic device 16 converts an electrical signal into voice and emits the voice. Applicable examples of the acoustic device 16 include a magnetic loudspeaker, a dynamic loudspeaker, a capacitor loudspeaker, and any other loudspeakers known in the technical field.

The following is an explanation of an example of voice activity detection processing executed with the processing circuit 11 of the voice activity detection apparatus 100. To specifically execute the following explanation, suppose that the non-acoustic signal is an image signal.

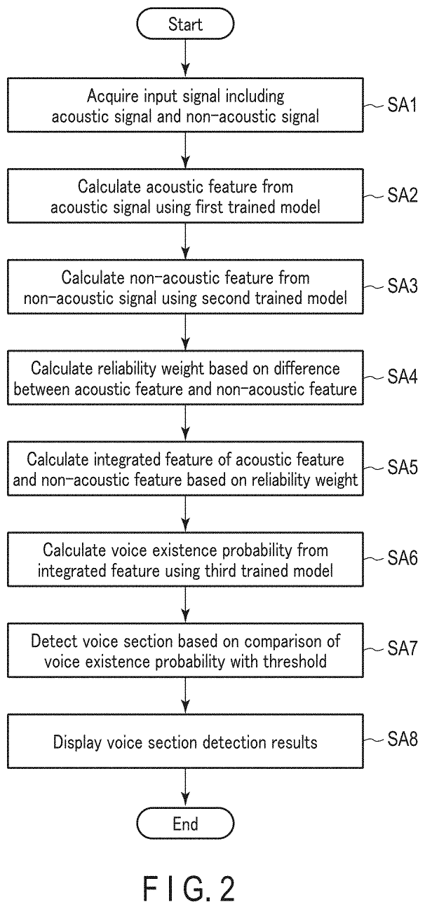

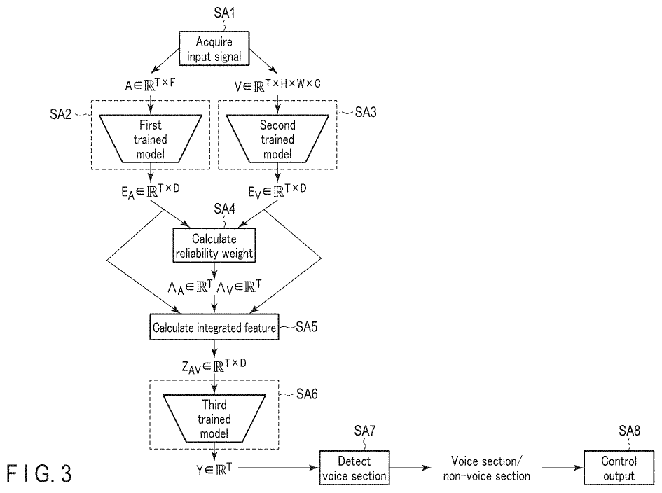

FIG. 2 is a diagram illustrating an example of flow of voice activity detection processing executed with the processing circuit 11. FIG. 3 is a diagram schematically illustrating the voice activity detection processing. The voice activity detection processing is executed with an operation of the processing circuit 11 in accordance with the voice activity detection program stored in the storage device 12 or the like.

As illustrated in FIG. 2 and FIG. 3, the input signal acquisition unit 111 acquires an input signal including an acoustic signal and an image signal (Step SA1). The input signal is a video signal including an acoustic signal and an image signal relating to the same voice generation source.

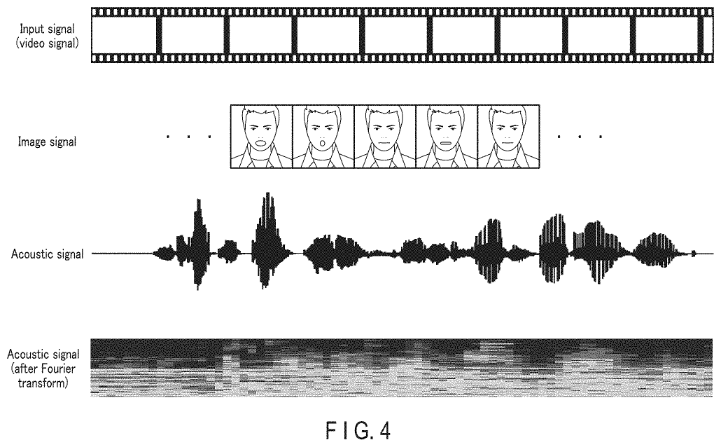

FIG. 4 is a diagram illustrating an example of an input signal (video signal), an acoustic signal, and an image signal. As illustrated in FIG. 4, a video signal is a time-series signal including a time-series acoustic signal and a time-series image signal temporally synchronized with each other. The length of the time sections of the video signal is not particularly limited, but is supposed to be a frame length of 10 seconds or around.

The video signal is collected with a video camera device including a microphone and an imaging device. The acoustic signal is collected with the microphone. The microphone collects voice relating to utterance of the speaker, converts the sound pressure of the collected voice into an analog electrical signal (acoustic signal), and subjects the acoustic signal to A/D conversion to convert the acoustic signal into a digital time region electrical signal (acoustic signal). The time region acoustic signal is acquired with the input signal acquisition unit 111, and converted into a frequency region acoustic signal by short-time Fourier transform or the like. The image signal is collected almost simultaneously with the acoustic signal. The image signal is collected with the imaging device including a plurality of imaging elements, such as a CCD (Charge Coupled Device). The imaging device optically images the uttering speaker, and generates an image signal (image data) of a digital spatial region image signal (image data) relating to the speaker in units of frame. The image signal is required to be correlated with the speaker's utterance. As the imaging target, the image frame is required to include at least a lip area the form of which is changed in accordance with utterance. The image frame may include the whole face region of the speaker. The image signal is acquired in units of frame with the input signal acquisition unit 111.

In this example, suppose that the time-series acoustic signal A and the time-series image signal V are defined in accordance with the following expression (1). The time-series acoustic signal A is an acoustic signal including a T dimension of the time region and a F dimension of the frequency region of the frame serving as the processing target. The image signal V is an image signal including dimensions of the time T, the height H, the width W, and a color channel C.

A∈ [symbol] ^{T×F}

V∈ [symbol] ^{T×H×W×C} (1)

When Step SA1 is executed, the acoustic feature calculation unit 112 calculates an acoustic feature E_{A} from the acoustic signal A acquired at Step SA1 using the first trained model (Step SA2). The acoustic feature E_{A} is calculated on the basis of the acoustic signal A for each of the frames. The acoustic feature E_{A} is time-series data. The first trained model is a neural network trained to receive the acoustic signal A and output the acoustic feature E_{A}. For example, an encoder network trained to convert the acoustic signal A into the acoustic feature E_{A} is used as the neural network. The first trained model is generated with a learning apparatus described later.

The relation between the acoustic signal and the acoustic feature herein is as follows. The acoustic signal is time-series waveform data of sound pressure values of the voice uttered by the speaker. The acoustic signal is correlated with the voice uttered by the speaker. For example, the peak value of the acoustic signal has a relatively high value when the speaker utters, and has a relatively low value when the speaker does not utter. The acoustic feature is designed such that the value has correlation with the peak value of the acoustic signal, in other words, to distinguish a voice component and a silent component included in the acoustic signal. For example, the value of the acoustic feature increases as the peak value of the acoustic signal increases, and the value of the acoustic feature decreases as the peak value of the acoustic signal decreases.

When Step SA2 is executed, the non-acoustic feature calculation unit 113 calculates an image feature Eᵥ from the image signal V acquired at Step SA1 using the second trained model (Step SA3). The image feature E_{V} is calculated on the basis of the image signal V for each of frames. Specifically, the image feature E_{V} is time-series data. The second trained model is a neural network trained to receive the image signal V and output the image feature E_{V}. For example, an encoder network trained to convert the image signal V into the image feature E_{V} is used as the neural network. The second trained model is generated with a learning apparatus described later.

The relation between the image signal and the image feature is as follows. The image signal is correlated with the form of the face part region at the time when the speaker is uttering voice. The image feature is designed to distinguish an utterance component from a non-utterance component included in the image signal. Specifically, the lip area of the speaker indicated with the image signal has different forms between the time when the speaker utters voice and the time when the speaker does not utter sound. The image feature is designed such that the value thereof is correlated with the form of the face part region of the speaker. For example, the image feature has a higher value as the speaker opens one's mouth wider, and the image feature has a lower value as the speaker closes one's mouth.

The order of Step SA2 and Step SA3 is not particularly limited. Step SA2 may be executed after Step SA3, or Step SA2 and Step SA3 may be executed in parallel.

When Step SA3 is executed, the reliability weight calculation unit 114 calculates a reliability weight on the basis of a difference between the acoustic feature calculated at Step SA2 and the image feature calculated at Step SA3 (Step SA4). At Step SA4, first, the reliability weight calculation unit 114 calculates a first reliability weight Λ_{A} calculated as a value between an intermediate value (for example, 0.5) and an upper limit value (for example, 1) for the difference between the acoustic feature E_{A} and the non-acoustic feature E_{V}, and a second reliability weight Λ_{V} calculated as a value acquired by subtracting the first reliability weight from the upper limit value. The first reliability weight Λ_{A} and the second reliability weight Λ_{V} are expressed with the following expressions (2) and (3). Specifically, the first reliability weight Λ_{A} is based on Kullback-Leibler divergence serving as a scale to measure a difference between the acoustic feature E_{A} and the non-acoustic feature E_{V}. The first reliability weight Λ_{A} is a scale acquired by non-linearly converting the Kullback-Leibler divergence based on the acoustic feature E_{A} and the image feature E_{V} in a range from the intermediate value (for example, 0.5) to the upper limit value (for example, 1). As expressed with the expression (3), the second reliability weight Λ_{V} is a scale having a value acquired by subtracting the first reliability weight Λ_{A} from the upper limit value.

$${Λ}_{A}^{( t )} = 1 - \frac{1}{2} \cdot exp ( - δ \cdot {\sum }_{d = 1}^{D} {E}_{A}^{( t , d )} \cdot log ( \frac{{E}_{A}^{( t , d )}}{{E}_{V}^{( t , d )}} ) ) ∈ [ 0.5 , 1 ) \qquad ( 2 )$$

$${Λ}_{v}^{( t )} = ( 1 - {Λ}_{A}^{( t )} ) ∈ ( 0 , 0.5 ] \qquad ( 3 )$$

In the expression, E_{A}^{(t, d)} is an acoustic feature vector at the frame time t∈{1, 2, . . . , T} and the coordinates d∈{1, 2, . . . , D} compressed to D dimension, and serves as an example of the acoustic feature. E_{V}^{(t, d)} is an image feature vector at the frame time t∈{1, 2, . . . , T} and coordinates d∈{1, 2, . . . , D} compressed to the D dimension, and an example of the image feature. The sign δ indicates a scale factor enlarging and/or reducing the magnitude of the difference between the acoustic feature E_{A} and the image feature E_{V}. Each of the first reliability weight Λ_{A} and the second reliability weight Λ_{V} is a weight depending on the frame time t.

As described later, the first trained model and the second trained model are trained to reduce a difference between the acoustic feature E_{A} and the image feature E_{V} with respect to the normal input for the same voice generation source. Because of use of the first trained model and the second trained model trained like this, in the case where input of an abnormal image occurs, the difference between the acoustic feature E_{A} and the image feature E_{V} increases. In this case, the first reliability weight Λ_{A} has a value close to the upper limit value, and the second reliability weight Λ_{V} has a value close to the lower limit value on the basis of the expressions (2) and (3).

When Step SA4 is executed, the integrated feature calculation unit 115 calculates an integrated feature of the acoustic feature and the non-acoustic feature on the basis of the reliability weight calculated at Step SA4 (Step SA5). At Step S5, the integrated feature calculation unit 115 calculates an integrated feature of the acoustic feature E_{A} and the non-acoustic feature E_{V} using the first reliability weight Λ_{A} and the second reliability weight Λ_{V}. The integrated feature Z_{AV} is calculated for each frame time t. Specifically, the integrated feature Z_{AV} is calculated as a sum of an integrated value of the first reliability weight Λ_{A} and the acoustic feature E_{A} and the integrated value of the second reliability weight Λ_{V} and the image feature E_{V}, as expressed with the following expression (4).

Z_{AV}^{(t,d)}=Λ_{A}^{(t)}·E_{A}^{(t,d)}+Λᵥ^{(t)}·E_{V}^{(t,d)} (4)

When Step SA5 is executed, the voice existence probability calculation unit 116 calculates a voice existence probability Y using the third trained model from the integrated feature Z_{AV} acquired at Step SA5 (Step SA6). The voice existence probability Y indicates a probability of existence of voice in the frame. The voice existence probability Y is calculated on the basis of the integrated feature Z_{AV} for each of the frames. The third trained model is a neural network trained to receive the integrated feature Z_{AV} and provide a penalty for a difference between a correct label relating to the voice section and the voice existence probability. For example, an estimation network trained to estimate a voice existence probability Y from the integrated feature Z_{AV} is used as the neural network. The third trained model is generated with a learning apparatus described later.

When Step SA6 is executed, the voice section detection unit 117 detects a voice section on the basis of comparison of the voice existence probability Y calculated at Step SA6 with a threshold n (Step SA7).

The value of the voice existence probability Y is compared with a threshold n for each frame time. The threshold n is set to a boundary between the value corresponding to utterance and the value not corresponding to utterance. For example, when the voice existence probability Y has the value ranging from “0” to “1”, the threshold q is set to the value “0.5”. In the case where the value of the voice existence probability Y is larger than the threshold n, the frame time is determined as a voice section. In the case where the value of the voice existence probability Y is smaller than the threshold n, the frame time is determined as a non-voice section. By executing the determination processing for each frame time, the voice sections and the non-voice sections are detected in the time sections corresponding to the input signal. A label of a voice section or a non-voice section is assigned to each frame time of the input signal.

When Step SA7 is executed, the output control unit 118 outputs the voice sections and/or the non-voice sections detected at Step SA7 (Step SA8). Various forms are possible as the output form. As an example, at Step SA8, the output control unit 118 displays the voice sections and/or the non-voice sections on the display device 15. In this operation, the output control unit 18 preferably displays the voice sections and/or the non-voice sections in visually association with the acoustic signal and/or the image signal.

The voice activity detection processing with the processing circuit 11 is finished with the operation described above. The input signal after voice activity detection is subjected to processing, such as voice recognition and data compression.

As described above, the voice activity detection apparatus 100 according to the present embodiment includes the acoustic feature calculation unit 112, the non-acoustic feature calculation unit 113, the reliability weight calculation unit 114, the integrated feature calculation unit 115, the voice existence probability calculation unit 116, and the voice section detection unit 117. The acoustic feature calculation unit 112 calculates an acoustic feature on the basis of the acoustic signal. The acoustic feature has a value correlated with pronunciation. The non-acoustic feature calculation unit 113 calculates an acoustic feature on the basis of the non-acoustic signal. The non-acoustic feature has a value correlated with pronunciation. The reliability weight calculation unit 114 calculates a reliability weight on the basis of the acoustic feature and the non-acoustic feature. The integrated feature calculation unit 115 calculates an integrated feature of the acoustic feature and the non-acoustic feature on the basis of the reliability weight. The voice existence probability calculation unit 116 calculates a voice existence probability from the integrated feature. The voice section detection unit 117 detects a voice section serving as a time section in which voice is uttered and/or a non-voice section serving as a time section in which no voice is uttered, on the basis of comparison of the voice existence probability with the threshold.

According to the present embodiment, when a voice existence probability is calculated from the integrated feature of the acoustic feature based on the acoustic signal and the non-acoustic feature based on the non-acoustic signal, a reliability weight is calculated for each of the acoustic feature and the non-acoustic feature, and the integrated feature and the voice existence probability are calculated in consideration of the reliability weights. This structure enables detection of a voice section with high accuracy even in the case where a continuous or sudden abnormal non-acoustic signal occurs. In addition, preferably, the acoustic feature is calculated from the acoustic signal using the first trained model, and the non-acoustic feature is calculated from the non-acoustic signal using the second trained model. Each of the first trained model and the second trained model is generated by learning using a loss function defined to provide a penalty for a difference between the acoustic feature and the non-acoustic feature output for the same voice generation source. By acquiring the acoustic feature and the non-acoustic feature using the first trained model and the second trained model acquired by such learning, a difference between the acoustic feature and the non-acoustic feature decreases for input of a normal non-acoustic signal, and a difference between the acoustic feature and the non-acoustic feature increases for input of an abnormal non-acoustic signal. By using such a difference value between the acoustic feature and the non-acoustic feature as a reliability weight and acquiring an integrated feature of the weighted acoustic feature and the weighted non-acoustic feature, the accuracy of detection of the voice section and/or the non-voice section can be further improved even if input of an abnormal non-acoustic signal occurs.

### Learning Apparatus

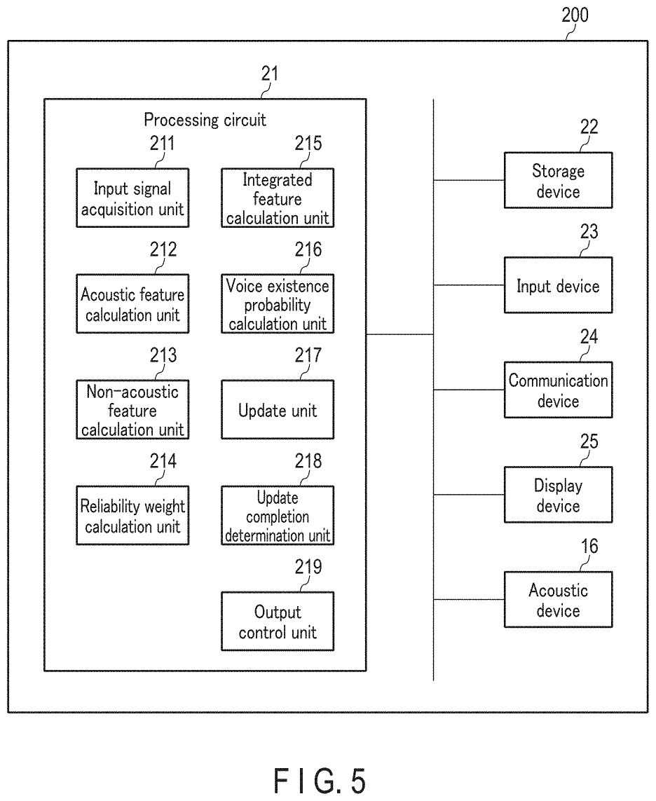

FIG. 5 is a diagram illustrating a configuration example of a learning apparatus 200. The learning apparatus 200 is a computer generating a first trained model used for calculation of the acoustic feature, a second trained model used for calculation of the image feature, and a third trained model used for detection of a voice section and/or a non-voice section. As illustrated in FIG. 5, the learning apparatus 200 includes a processing circuit 21, a storage device 22, an input device 23, a communication device 24, a display device 25, and an acoustic device 26.

The processing circuit 21 includes a processor, such as a CPU, and a memory, such as a RAM. The processing circuit 21 executes learning processing to generate the first trained model, the second trained model, and the third trained model, by executing a learning program stored in the storage device 22. The learning program is recorded on a non-transitory computer-readable storage medium. The processing circuit 21 achieves an input signal acquisition unit 211, an acoustic feature calculation unit 212, a non-acoustic feature calculation unit 213, a reliability weight calculation unit 214, an integrated feature calculation unit 215, a voice existence probability calculation unit 216, an update unit 217, an update completion determination unit 218, and an output control unit 219, by reading and executing the learning program from the storage medium. The learning program may include a plurality of modules implemented with functions of the units 211 to 219 in a divided manner.

Hardware implementation of the processing circuit 21 is not limited to only the mode described above. For example, the processing circuit 21 may be formed of a circuit, such as an application specific integrated circuit (ASIC), achieving the input signal acquisition unit 211, the acoustic feature calculation unit 212, the non-acoustic feature calculation unit 213, the reliability weight calculation unit 214, the integrated feature calculation unit 215, the voice existence probability calculation unit 216, the update unit 217, the update completion determination unit 218, and the output control unit 219. The input signal acquisition unit 211, the acoustic feature calculation unit 212, the non-acoustic feature calculation unit 213, the reliability weight calculation unit 214, the integrated feature calculation unit 215, the voice existence probability calculation unit 216, the update unit 217, the update completion determination unit 218, and the output control unit 219 may be implemented in a single integrated circuit or individually implemented in a plurality of integrated circuits.

The input signal acquisition unit 211 acquires training data including a plurality of training samples. Each of the training samples is an input signal including a pair of an acoustic signal and a non-acoustic signal. The input signal is a time-series signal, and includes a time-series acoustic signal and a time-series non-acoustic signal. As described above, the non-acoustic signal is an image signal relating to the uttering speaker, and/or a sensor signal relating to physiological response of lips and/or a face muscle of the speaker generated by utterance.

The acoustic feature calculation unit 212 calculates an acoustic feature from the acoustic signal using a first neural network. The acoustic feature calculated with the acoustic feature calculation unit 212 is similar to the acoustic feature calculated with the acoustic feature calculation unit 112. The first trained model is generated by training the first neural network.

The non-acoustic feature calculation unit 213 calculates a non-acoustic feature from the non-acoustic signal using a second neural network. The non-acoustic feature calculated with the non-acoustic feature calculation unit 213 is similar to the non-acoustic feature calculated with the non-acoustic feature calculation unit 113. The second trained model is generated by training the second neural network.

The first neural network and the second neural network are trained to provide a penalty for a difference between the acoustic feature and the non-acoustic feature relating to the same voice generation source.

The reliability weight calculation unit 214 calculates a reliability weight on the basis of a difference between the acoustic feature and the non-acoustic feature. The reliability weight calculated with the reliability weight calculation unit 214 is similar to the reliability weight calculated with the reliability weight calculation unit 114.

The integrated feature calculation unit 215 calculates an integrated feature of the acoustic feature and the non-acoustic feature on the basis of the reliability weight calculated with the reliability weight calculation unit 214. The integrated feature calculated with the integrated feature calculation unit 215 is similar to the integrated feature calculated with the integrated feature calculation unit 115.

The voice existence probability calculation unit 216 calculates a voice existence probability from the integrated feature using a third neural network. The voice existence probability calculated with the voice existence probability calculation unit 216 is similar to the voice existence probability calculated with the voice existence probability calculation unit 116. The third neural network is trained to provide a penalty for a difference between a correct label relating to the voice section and the non-voice section and the voice existence probability. The third trained model is generated by training the third neural network.

The update unit 217 updates the first neural network, the second neural network, and the third neural network using a total loss function including a first loss function to provide a penalty for a difference between the acoustic feature and the non-acoustic feature relating to the same voice generation source and a second loss function to provide a penalty for a difference between a correct label relating to the voice section and the non-voice section and the voice existence probability.

The update completion determination unit 218 determines whether the condition for stopping the learning processing is satisfied. In the case where it is determined that the stop condition is not satisfied, the processing circuit 21 repeats calculation of the acoustic feature with the acoustic feature calculation unit 212, calculation of the non-acoustic feature with the non-acoustic feature calculation unit 213, calculation of the reliability weight with the reliability weight calculation unit 214, calculation of the integrated feature with the integrated feature calculation unit 215, calculation of the voice existence probability with the voice existence probability calculation unit 216, and update of the first neural network, the second neural network, and the third neural network with the update unit 217. In the case where it is determined that the stop condition is satisfied, the first neural network at this point in time is output as the first trained model, the second neural network at this point in time is output as the second trained model, and the third neural network at this point in time is output as the third trained model.

The output control unit 219 displays various types of information via the display device 25 and/or the acoustic device 26. For example, the output control unit 219 displays an image signal on the display device 25 and/or outputs an acoustic signal via the acoustic device 26.

The storage device 22 is formed of, for example, a ROM, a HDD, a SSD, and/or an integrated circuit storage device. The storage device 22 stores therein various arithmetic calculation results acquired with the processing circuit 21 and/or the learning program executed with the processing circuit 21 and the like. The storage device 22 is an example of a computer-readable storage medium.

The input device 23 inputs various commands from the user. Applicable examples of the input device 23 include a keyboard, a mouse, various types of switches, a touch pad, and a touch panel display. The output signal from the input device 23 is supplied to the processing circuit 21. The input device 23 may be a computer connected with the processing circuit 21 in a wired or wireless manner.

The communication device 24 is an interface to execute information communication with an external device connected with the learning apparatus 200 via a network.

The display device 25 displays various types of information. Applicable examples of the display device 25 include a CRT display, a liquid crystal display, an organic EL display, a LED display, a plasma display, and any other displays known in the technical field. The display device 25 may be a projector.

The acoustic device 26 converts an electrical signal into voice and emits the voice. Applicable examples of the acoustic device 26 include a magnetic loudspeaker, a dynamic loudspeaker, a capacitor loudspeaker, and any other loudspeakers known in the technical field.

The following is an explanation of an example of learning processing executed with the processing circuit 21 of the learning apparatus 200. To specifically execute the following explanation, suppose that the non-acoustic signal is an image signal.

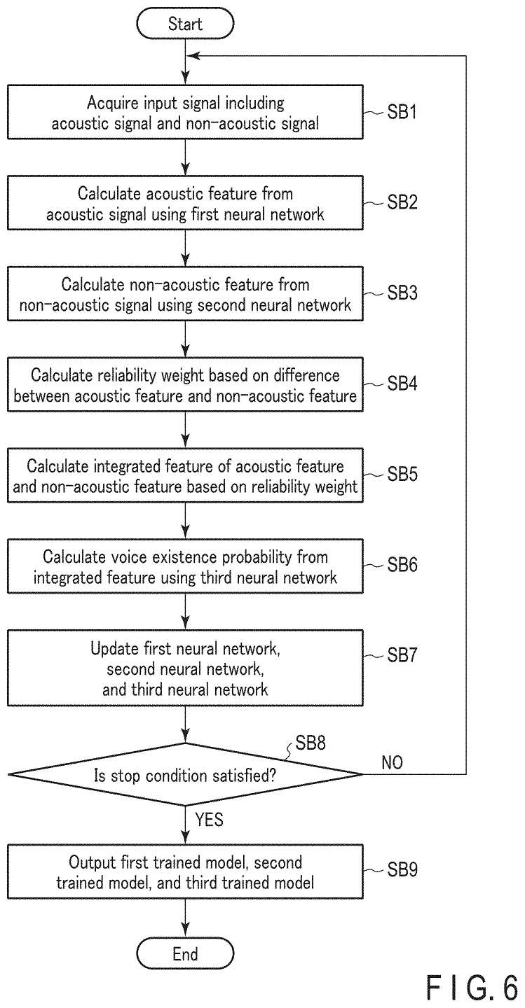

FIG. 6 is a diagram illustrating an example of flow of learning processing executed with the processing circuit 21. The learning processing is executed by operation of the processing circuit 21 in accordance with the learning program stored in the storage device 22 or the like. In the learning processing, the processing circuit 21 trains a first neural network NN1, a second neural network NN2, and a third neural network NN3 in parallel. More specifically, the processing circuit 21 subjects an integrated neural network including the first neural network NN1, the second neural network NN2, and the third neural network NN3 to supervised learning using training data.

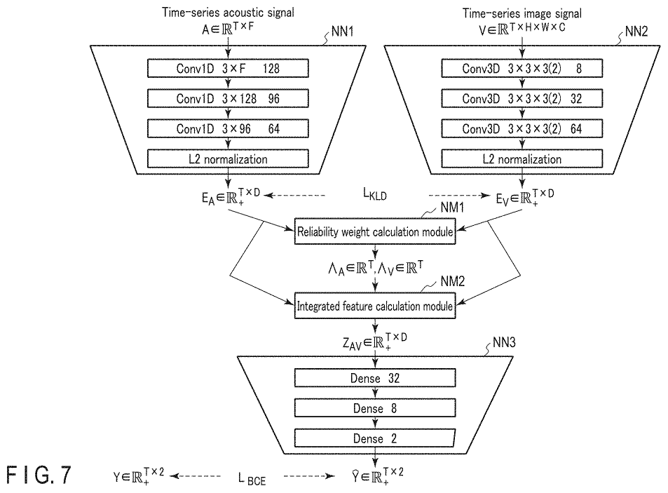

FIG. 7 is a diagram illustrating a configuration example of an integrated neural network. As illustrated in FIG. 7, the integrated neural network includes the first neural network NN1, the second neural network NN2, a reliability weight calculation module NM1, an integrated feature calculation module NM2, and the third neural network NN3. The first neural network NN1 receives an acoustic signal A and outputs an acoustic feature E_{A}. The second neural network NN2 receives an image signal V and outputs an image feature E_{V}. The reliability weight calculation module NM1 receives the acoustic feature E_{A} output from the first neural network NN1 and the non-acoustic feature E_{V} output from the second neural network NN2, and outputs a reliability weight A, that is, a first reliability weight Λ_{A} and a second reliability weight Λ_{V}. The reliability weight calculation module NM1 is a module corresponding to the function of the reliability weight calculation unit 214. The integrated feature calculation module NM2 receives the acoustic feature E_{A} output from the first neural network NN1, the non-acoustic feature E_{V} output from the second neural network NN2, and the first reliability weight AA and the second reliability weight Λ_{V} output from the reliability weight calculation module NM1, and outputs an integrated feature Z_{AV}. The integrated feature calculation module NM2 is a module corresponding to the function of the integrated feature calculation unit 215. The third neural network NN3 receives the integrated feature Z_{AV} output from the integrated feature calculation module NM2, and outputs a voice existence probability Y\hat{ }. Suppose that initial values of learning parameters or the like are assigned to the first neural network NN1, the second neural network NN2, and the third neural network NN3. The learning parameters are weights and/or biases and the like. Desired hyperparameters may be included as the learning parameters.

The first neural network NN1 has architecture of an encoder network capable of calculating the acoustic feature E_{A} from the acoustic signal A. As an example, the first neural network NN1 includes three one-dimensional convolutional layers and a L2 normalization layer. The second neural network NN2 has architecture of an encoder network capable of calculating the image feature E_{V} from the image signal V. As an example, the second neural network NN2 includes three three-dimensional convolutional layers and a L2 normalization layer. At least one of the three three-dimensional convolutional layers is preferably connected to a maximum value pooling layer and/or a global mean value pooling layer. The third neural network NN3 has architecture of a detection network capable of calculating a voice existence probability Y\hat{ } from the integrated feature Z_{AV}. As an example, the third neural network NN3 includes three dense (Dense) layers. Each of all the convolutional layers and the Dense layers of the first neural network NN1, the second neural network NN2, and the third neural network NN3 are followed by a normalization linear function unit, and a normalization linear function is applied to the output of the layer. The final layer of each of the first neural network NN1, the second neural network NN2, and the third neural network NN3 is followed by a sigmoid activation function unit, not a normalization linear function unit, and a sigmoid function is applied to the output of the final layer.

The integrated neural network receives the acoustic signal A and the image signal V, and outputs a voice existence probability Y\hat{ }. The learning parameters of the first neural network NN1, the second neural network NN2, and the third neural network NN3 are trained to minimize the total loss function evaluating an error between the voice existence probability Y\hat{ } and the correct label (ground truth) Y. The following is an explanation of learning of the first neural network NN1, the second neural network NN2, and the third neural network NN3 with reference to FIG. 6 and FIG. 7.

As illustrated in FIG. 6 and FIG. 7, the input signal acquisition unit 211 acquires an input signal including an acoustic signal A and an image signal V (Step SB1). At Step SB1, an input signal serving as a training sample is acquired. The frame length of the time sections of the input signal is not particularly limited, but is supposed to be, for example, 10 frames or around. The acoustic signal A and the image signal V included in the input signal are temporally synchronized with each other.

When Step SB1 is executed, the acoustic feature calculation unit 212 calculates an acoustic feature E_{A} from the acoustic signal A acquired at Step SB1 using the first neural network (Step SB2). Learning of the first neural network at Step SB2 is not finished. The acoustic signal A input to the first neural network NN1 has been converted from the time region into the frequency region.

When Step SB2 is executed, the non-acoustic feature calculation unit 213 calculates an image feature E_{V} from the image signal V acquired at Step SB1 using the second neural network (Step SB3). Learning of the second neural network at Step SB3 is not finished.

The order of Step SB2 and Step SB3 is not particularly limited. Step SB2 may be executed after Step SB3, or Step SB2 and Step SB3 may be executed in parallel.

When Step SB3 is executed, the reliability weight calculation unit 214 calculates a reliability weight using the reliability weight calculation module NM1 on the basis of a difference between the acoustic feature E_{A} calculated at Step SB2 and the image feature E_{V} calculated at Step SB3 (Step SB4). At Step SB4, first, the reliability weight calculation unit 214 calculates a first reliability weight AA calculated as a value between an intermediate value (for example, 0.5) and an upper limit value (for example, 1) for the difference between the acoustic feature E_{A} and the non-acoustic feature E_{V}, and a second reliability weight Λ_{V} calculated as a value acquired by subtracting the first reliability weight from the upper limit value.

When Step SB4 is executed, the integrated feature calculation unit 215 calculates an integrated feature Z_{AV} of the acoustic feature E_{A} and the image feature E_{V} using the integrated feature calculation module NM2 on the basis of the reliability weights Λ_{A} and Λ_{V} calculated at Step SB4 (Step SB5). At Step SB5, the integrated feature calculation unit 215 calculates the integrated feature of the acoustic feature E_{A} and the image feature E_{V} using the first reliability weight Λ_{A} and the second reliability weight Λ_{V}. The integrated feature Z_{AV} is calculated for each frame time t. In the case where the image signal includes no abnormal images but includes only normal images at the learning stage, the first reliability weight Λ_{A} and the second reliability weight Λ_{V} may be set to the intermediate value 0.5.

When Step SB5 is executed, the voice existence probability calculation unit 216 calculates the voice existence probability Y\hat{ } using the third neural network NN3 from the integrated feature Z_{AV} acquired at Step SB5 (Step SB6).

When Step SB6 is executed, the update unit 217 updates the first neural network NN1, the second neural network NN2, and the third neural network NN3 using a total loss function L_{TOTAL} including a first loss function L_{KLD} to provide a penalty for a difference between the acoustic feature and the non-acoustic feature relating to the same voice generation source and a second loss function L_{BCE} to provide a penalty for a difference between a correct label relating to the voice section and the non-voice section and the voice existence probability (Step SB7). As expressed with the following expression (5), the total loss function L_{TOTAL} at the frame time t and the coordinates d is provided by a sum of the first loss function L_{KLD} and the second loss function L_{BCE}. Specifically, the first loss function L_{KLD} is provided by the Kullback-Leibler divergence based on the acoustic feature E_{A} and the image feature E_{V}, as expressed with the following expression (6). The Kullback-Leibler divergence is used as a scale to evaluate a difference between the acoustic feature E_{A} and the image feature E_{V}. As expressed with the following expression (7), the second loss function L_{BCS} is provided by binary cross entropy (BCE). Binary cross entropy is used as a scale to evaluate a difference between a correct label y relating to the voice section and the non-voice section and the voice existence probability y\hat{ }.

$${ℒ}_{total}^{( t )} = {ℒ}_{KLD}^{( t )} + {ℒ}_{BCE}^{( t )} \qquad ( 5 )$$

$${ℒ}_{KLD}^{( t )} = {\sum }_{d = 1}^{D} {E}_{A}^{( t , d )} \cdot log ( \frac{{E}_{A}^{( t , d )}}{{E}_{V}^{( t , d )}} ) \qquad ( 6 )$$

$${ℒ}_{BCE}^{( t )} = - {\sum }_{k = 1}^{K = 2} {y}^{( t , k )} \cdot log ( {\hat{y}}^{( t , k )} ) \qquad ( 7 )$$

The update unit 217 updates learning parameters of the first neural network NN1, the second neural network NN2, and the third neural network NN3 to minimize the total loss function L_{TOTAL}, in accordance with a desired optimization method. In this manner, the update unit 217 updates the learning parameters of the first neural network NN1, the second neural network NN2, and the third neural network NN3 to minimize a difference between the acoustic feature E_{A} and the image feature E_{V} and a difference between the correct label y and the voice existence probability y\hat{ } comprehensively. Any method, such as a stochastic gradient descent and adaptive moment estimation (Adam), may be used as the optimization method.

When Step SB7 is executed, the update completion determination unit 218 determines whether the stop condition is satisfied (Step SB8). The stop condition may be, for example, a condition that the number of updates of the learning parameters has reached a predetermined number of times and/or a condition that the update quantity of the learning parameters is less than the threshold. When it is determined that the stop condition is not satisfied (Step SB8: NO), the input signal acquisition unit 211 acquires another acoustic signal and another image signal (Step SB1). Thereafter, the acoustic signal and the image signal is successively subjected to calculation of the acoustic feature with the acoustic feature calculation unit 212 (Step SB2), calculation of the non-acoustic feature with the non-acoustic feature calculation unit 213 (Step SB3), calculation of the reliability weight with the reliability weight calculation unit 214 (Step SB4), calculation of the integrated feature with the integrated feature calculation unit 215 (Step SB5), calculation of the voice existence probability with the voice existence probability calculation unit 216 (Step SB6), update of the first neural network, the second neural network, and the third neural network with the update unit 217 (Step SB7), and determination with the update completion determination unit 218 as to whether the stop condition is satisfied (Step SB8).

Steps SB2 to SB7 may be repeated for a training sample (batch learning), or Steps SB2 to SB7 may be repeated for a plurality of training samples (mini-batch learning).

When it is determined at Step SB8 that the stop condition is satisfied (Step SB8: YES), the update completion determination unit 218 outputs the first neural network NN1 at the time when the stop condition is satisfied as the first trained model, the second neural network NN2 at the time when the stop condition is satisfied as the second trained model, and the third neural network NN3 at the time when the stop condition is satisfied as the third trained model (Step SB9). The first trained model, the second trained model, and the third trained model are transmitted to the voice activity detection apparatus 100 via the communication device 24 or the like, and stored in the storage device 12. The update completion determination unit 218 may output an integrated neural network including the first trained model, the second trained model, the third trained model, the reliability weight calculation module NM1, and the integrated feature calculation module NM2.

When the step SB8 is executed, learning processing with the processing circuit 21 is finished. As described above, the voice activity detection apparatus 100 calculates a voice existence probability from the acoustic signal and the image signal using the first trained model, the second trained model, and the third trained model generated with the learning apparatus 200. The voice activity detection apparatus 100 may calculate a voice existence probability by inputting the acoustic signal and the image signal to the integrated neural network.

As described above, the learning apparatus 200 according to the present embodiment includes the input signal acquisition unit 211, the acoustic feature calculation unit 212, the non-acoustic feature calculation unit 213, the reliability weight calculation unit 214, the integrated feature calculation unit 215, the voice existence probability calculation unit 216, and the update unit 217. The input signal acquisition unit 211 acquires an acoustic signal and a non-acoustic signal relating to the same voice generation source. The acoustic feature calculation unit 212 calculates an acoustic feature from the acoustic signal using the first neural network. The non-acoustic feature calculation unit 213 calculates a non-acoustic feature from the non-acoustic signal using the second neural network. The reliability weight calculation unit 214 calculates a reliability weight on the basis of a difference between the acoustic feature and the non-acoustic feature. The integrated feature calculation unit 215 calculates an integrated feature of the acoustic feature and the non-acoustic feature on the basis of the reliability weight. The voice existence probability calculation unit 216 calculates a voice existence probability from the integrated feature using the third neural network. The update unit 217 updates the first neural network, the second neural network, and the third neural network using a total loss function including a first loss function providing a penalty for a difference between the acoustic feature and the non-acoustic feature and a second loss function providing a penalty for a difference between a correct label relating to the voice section and the non-voice section and the voice existence probability.

By acquiring the acoustic feature and the non-acoustic feature using the first trained model and the second trained model acquired by such learning, a difference between the acoustic feature and the non-acoustic feature decreases for input of a normal non-acoustic signal, and a difference between the acoustic feature and the non-acoustic feature increases for input of an abnormal non-acoustic signal. By using such a difference value between the acoustic feature and the non-acoustic feature as a reliability weight and acquiring an integrated feature of the weighted acoustic feature and the weighted non-acoustic feature, the accuracy of detection of the voice section and/or the non-voice section can be further improved even if input of an abnormal non-acoustic signal occurs.

### Verification Example

Verification was executed for the performance of the integrated neural network (hereinafter referred to as “proposed model”) according to the present embodiment and including the first neural network, the second neural network, and the third neural network generated by the embodiment described above. An audio-only model, an AV-catenation model, a baseline model (AV-summation model), and the proposed model were trained and evaluated using a GRID-AV sentence corpus (hereinafter simply referred to as “GRID corpus”) formed of AV recording of 1000 sentences spoken by each of 34 speakers (18 men and 16 women).

For learning of the models in consideration of noise, background noises provided in the 4th CHiME challenge were selected at random, and mixed into all acoustic training data of the GRID corpus having a SNR falling within a range of −5 to +20 dB. The noises of the CHiME 4 were recorded in four places, that is, the bus, the cafeteria, the pedestrian area, and the street intersection. To evaluate the performance under matched noise conditions, the noises of the CHiME 4 were mixed into all test acoustic records of the GRID corpus at 5 dB intervals with the SNR in a range of −5 to +15 dB. In the same manner, to evaluate the performance under mismatched noise conditions, the background noises from an EastAnglia data set were mixed into all test acoustic records of the GRID corpus at 5 dB intervals with the SNR in a range of −5 to +15 dB. The EastAnglia data set provides environment noise collected in 10 places, that is, the bar, the beach, the bus, the car, the soccer game, the laundromat, the lecture, the office, the railway station, and on the road.

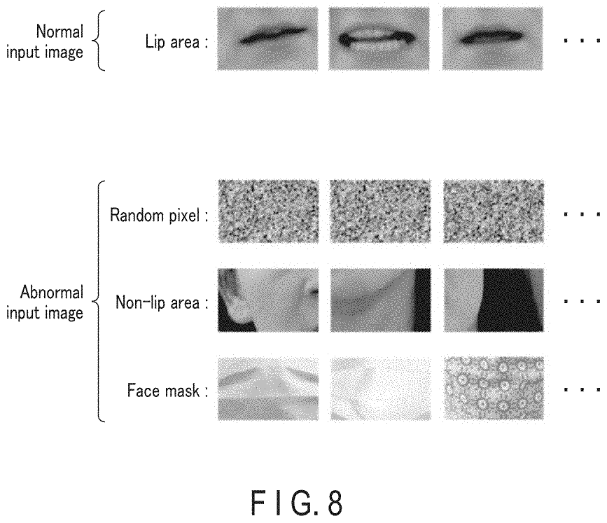

FIG. 8 is a diagram illustrating an example of an image signal (image data) according to the example. Because the GRID corpus includes no abnormal images, three types of abnormal images as illustrated in FIG. 8 were generated. The abnormal images were used only for evaluation. The first type is random pixel images in each of which random pixels supposing a video read error and/or a crash are uniformly distributed. The second type is non-lip area images extracted from the GRID corpus supposing a face landmark detection error. The third type is 10-type face mask images formed on the supposition that the speaker wearing a mask.

Records of each of the speakers of the GRID corpus were divided into a training data set, a verification data set, and a test data set at a ratio of 6:2:2. The verification data set was used to specify a hyperparameter suitable for each model and each experiment condition. With respect to the input voice, all the voice records were subjected to resampling at a sampling rate of 16 kHz, and 128-dimensional logarithmic compression mel-spectrogram was calculated using short-time Fourier transform having a window size of 1,280 samples (80 milliseconds) and a hop length of 640 samples (40 milliseconds). With respect to the input image, all the image records are cut into lip areas using a face landmark detector of 68 coordinates, and converted into 25 frames/seconds (40 milliseconds) with resolution of H×W=40×64 pixels, and the RGB channels were normalized between 0 to 1. All the models were trained by gradient clipping using Adam optimization. The learning rate was initialized to 0.0001, and the batch size was set to 1. The correct label of VAD of the expression (7) was generated by applying the VAD method to the corresponding good-quality voice data of the GRID corpus. The ground truth value of “k=1” was set to 1 in the case where the frame is an input acoustic frame including voice, and set to 0 in the case where the frame is a frame including no voice or including only noise. The scale factor 6 in the expression (2) was set to 100 in all the experiment conditions in the proposed model.

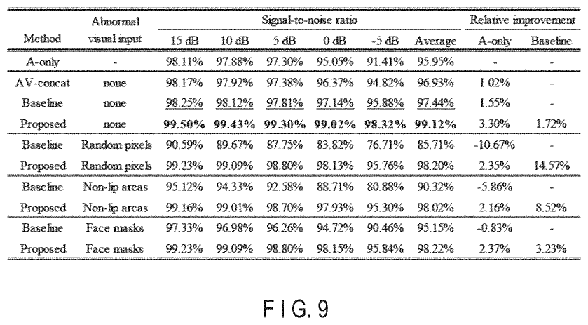

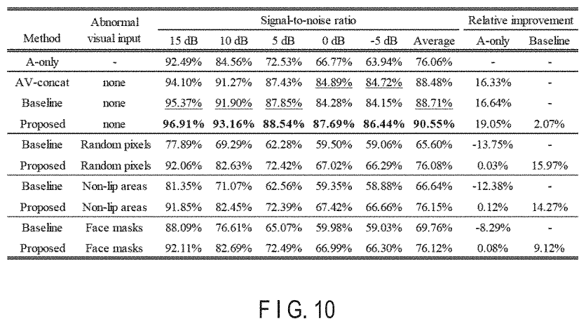

FIG. 9 is a table illustrating verification results under matched noise conditions using a data set of CHiME4. FIG. 10 is a table illustrating verification results under mismatched noise conditions using a data set of EastAnglia. FIG. 9 and FIG. 10 use an area under the receiver operating characteristic (AUROC) as an index of quantitative performance evaluation of AV-VAD. FIG. 9 and FIG. 10 illustrate evaluation results in the case where abnormal image input is present/absent for all the models. The bold-type characters indicate the best values, and the second best values are underlined.

In the case where no abnormal image is input, the AV model generally presented better results than the Audio-only (A-only) model, in particular, at a low SNR. The baseline (Baseline) model presented the best results on average in the AV models, except the proposed (Proposed) model. However, in the case where an abnormal image is input, the baseline model presented bad results and presented relative improvement rate of −13.75% at maximum in comparison with the Audio-only model.

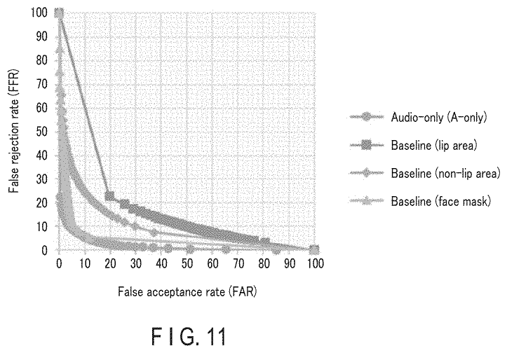

FIG. 11 is a diagram illustrating mean ROC curves of an Audio-only model and baseline models under matched noise conditions. As illustrated in FIG. 11, the false acceptance rate (FAR) tends to increase in the case of an abnormal input image in which a pixel value frequently varies between frames, and the false rejection rate (FRR) tends to increase in the case of abnormal image input (face mask). The results indicates that change of the pixel value relating to motion of the mouth is used as an important visual feature in AV-VAD.

The proposed model presented values markedly higher than those of the baseline models in all the experiment conditions, and presented relative improvement of 2.07$ at maximum for normal image input, and 15.97% at maximum for abnormal image input. In addition, the proposed model presented relative improvement of 2.37% at maximum for an abnormal input image in comparison with the Audio-only model. The proposed model acquired good results only for a normal input image in comparison with the baseline models by using the loss function expressed with the expression (5). The results present high similarity between the acoustic feature and the image feature in the latent space of AV-VAD. This structure improves the whole learning efficiency of neural networks relating to AV-VAD, and contributes to improvement of performance.

### Additional Example

The following is an explanation of the voice activity detection apparatus 100 according to an additional example of the present embodiment. In the following explanation, constituent elements having substantially the same functions as those of the present embodiment will be denoted by the same reference numerals, and an overlapping explanation is made only when necessary.

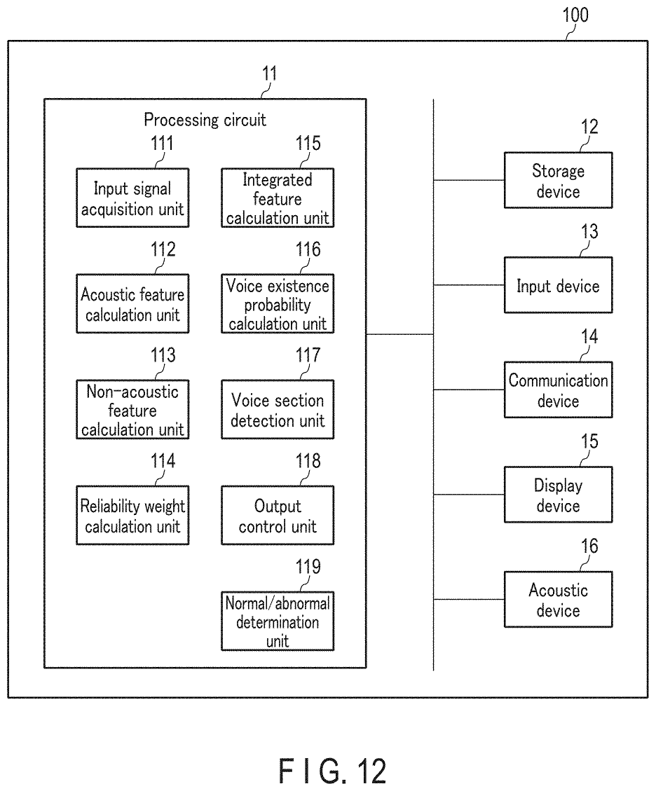

FIG. 12 is a diagram illustrating a configuration example of a voice activity detection apparatus according to the additional example. As illustrated in FIG. 12, the processing circuit 11 achieves a normal/abnormal determination unit 119, in addition to an input signal acquisition unit 111, an acoustic feature calculation unit 112, a non-acoustic feature calculation unit 113, a reliability weight calculation unit 114, an integrated feature calculation unit 115, a voice existence probability calculation unit 116, a voice section detection unit 117, and an output control unit 118.

The normal/abnormal determination unit 119 determines whether the non-acoustic signal acquired with the input signal acquisition unit 111 is a normal signal or an abnormal signal on the basis of the reliability weight calculated with the reliability weight calculation unit 114.

The output control unit 118 outputs a determination result as to whether the non-acoustic signal acquired with the input signal acquisition unit 111 is a normal signal or an abnormal signal to the display device 15 or the like.

The following is an explanation of an example of voice activity detection processing executed with the processing circuit 11 of the voice activity detection apparatus 100 according to the additional example. To specifically execute the following explanation, suppose that the non-acoustic signal is an image signal.

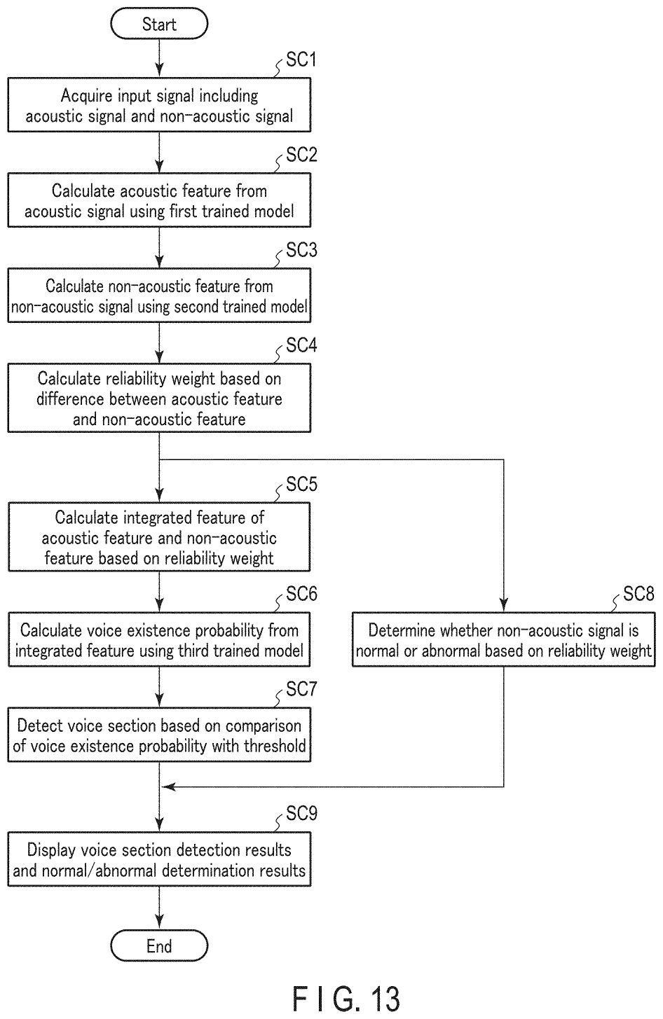

FIG. 13 is a diagram illustrating an example of flow of voice activity detection processing executed with the processing circuit 11 according to the additional example. The voice activity detection processing is executed with an operation of the processing circuit 11 in accordance with the voice activity detection program stored in the storage device 12 or the like. The details of Steps SC1 to SC7 illustrated in FIG. 13 are the same as those of Steps SA1 to SA7 illustrated in FIG. 2, and an explanation thereof herein is omitted.

As illustrated in FIG. 13, when Step SC4 is executed, Steps SC5 to SC7 are executed, and simultaneously the normal/abnormal determination unit 119 determines whether the non-acoustic signal (image signal) acquired at Step SC1 is a normal signal or an abnormal signal on the basis of the reliability weight calculated at Step SC4 (Step SC8). At Step SC8, the normal/abnormal determination unit 119 determines whether the image signal is a normal signal or an abnormal signal on the basis of comparison of the reliability weight with a predetermined threshold. Specifically, the normal/abnormal determination unit 119 compares a first reliability weight Λ_{A} with a threshold θ_{A}, determines that the image signal is abnormal in the case of “θ_{A}<Λ_{A}”, and determines that the image signal is normal in the case of “θ_{A}≥Λ_{A}”. The threshold θ_{A} can be experimentally or empirically set from any natural number in a range from the intermediate value (for example, 0.5) to the upper limit value (for example, 1.0). As an example, the threshold θ_{A} can be set to 0.7 or around. The second reliability weight Λ_{V} may be compared with a threshold θ_{V}. In the case of “θ_{V}<Λ_{V}”, the normal/abnormal determination unit 119 determines that the image signal is normal. In the case of “θ_{V}≥Λ_{V}”, the normal/abnormal determination unit 119 determines that the image signal is abnormal. The threshold θ_{V} can be experimentally or empirically set from any natural number in a range from the intermediate value (for example, 0.5) to the lower limit value (for example, 0.0). As an example, the threshold θ_{V} can be set to 0.3 or around.

When Step SC7 and Step SC8 are executed, the output control unit 118 outputs voice section detection results acquired at Step SC7 and normal/abnormal determination results acquired at Step SC8 (Step SC9). At Step SC9, the output control unit 118 displays the voice section detection results and the normal/abnormal determination results on the display device 15. As an example, the output control unit 118 displays a display screen including the voice section detection results and the normal/abnormal determination results on the display device 15.

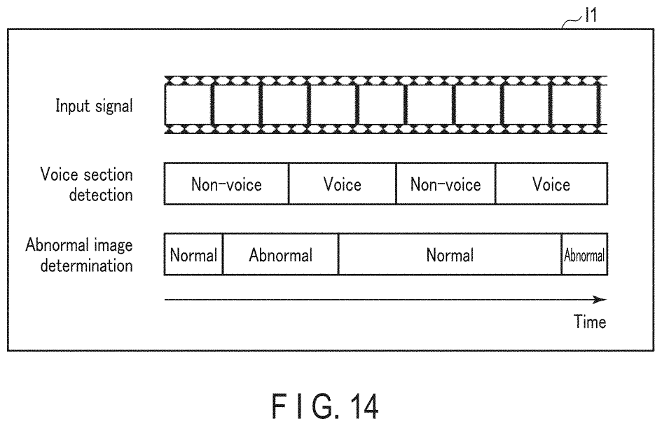

FIG. 14 is a diagram illustrating an example of a display screen I1 including the voice section detection results and the normal/abnormal determination results. As illustrated in FIG. 14, the display screen I1 displays the input signal, the voice section detection results, and the normal/abnormal determination results. The input signal being a video signal is displayed at predetermined frame intervals in time series in the lateral direction. As the voice section detection results, labels each indicating that the frame is a voice section or a non-voice section are displayed in time series. FIG. 14 illustrates labels “voice” indicating a voice section and labels “non-voice” indicating a non-voice section are displayed. As the normal/abnormal image determination results, labels each indicating that the image signal in the input signal of the frame is a normal signal or an abnormal signal are displayed in time series. FIG. 14 illustrates labels “normal” indicating a normal signal and labels “abnormal” indicating an abnormal signal.

The operator is enabled to recognize whether the image signal is abnormal or normal by observing the display screen I1. The operator is enabled to estimate the reliability of the voice section detection result by recognizing whether the image signal is abnormal or normal.

The voice activity detection processing with the processing circuit 11 according to the additional example is finished as described above.

The flow of the voice activity detection processing according to the additional example described above is an example, and the flow is not limited to the flow illustrated in FIG. 13. The determination processing with the normal/abnormal determination unit 119 at Step SC8 may be executed at any timing, as long as it is executed after the reliability weight calculation processing with the reliability weight calculation unit 114 at Step SC4. For example, the determination processing may be executed before Steps SC5 to SC7 are executed after the reliability weight calculation processing with the reliability weight calculation unit 114 at Step SC4. In this case, Step SC5 to SC7 are executed in the case where it is determined that the image signal is normal, and no Steps SC5 to SC7 may be executed in the case where it is determined that the image signal is abnormal. As described above, the whole processing quantity can be reduced by stopping the subsequent processing in the case where it is determined that the image signal is abnormal. In addition, because voice section detection is executed only in the case where it is determined that the image signal is normal, the reliability of voice section detection results increases.

The embodiment described above is an example, and various modifications are possible. For example, the acoustic signal is a voice signal in the embodiment, but may be a vocal cord signal or a vocal tract signal acquired by decomposing the voice signal. In addition, the acoustic signal is waveform data of sound pressure values in the time region or the frequency region in the embodiment, but may be data acquired by converting the waveform data into any space.

Accordingly, the embodiment described above suppresses reduction in detection accuracy due to abnormal image input.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A voice activity detection apparatus comprising a processing circuit, the processing circuit executing:
acquiring an acoustic signal and a non-acoustic signal relating to a same voice generation source;
calculating an acoustic feature based on the acoustic signal;
calculating a non-acoustic feature based on the non-acoustic signal;
calculating a reliability weight based on a difference between the acoustic signal and the non-acoustic signal;
calculating an integrated feature of the acoustic feature and the non-acoustic feature based on the reliability weight;
calculating a voice existence probability based on the integrated feature; and
detecting a voice section and/or a non-voice section based on comparison of the voice existence probability with a threshold, the voice section being a time section in which voice is presence, the non-voice section being a time section in which voice is absence.

2. The voice activity detection apparatus according to claim 1, wherein the processing circuit executes:
calculating the acoustic feature from the acoustic signal using a first trained model;
calculating the non-acoustic feature from the non-acoustic signal using a second trained model; and
calculating the voice existence probability from the integrated feature using a third trained model,
the first trained model and the second trained model is generated by learning to provide a penalty for the difference between the acoustic feature and the non-acoustic feature relating to the same voice generation source, and
the third trained model is generated by learning to provide a penalty for a difference between a correct label relating to the voice section and the non-voice section and the voice existence probability.

3. The voice activity detection apparatus according to claim 1, wherein the reliability weight includes a first reliability weight and a second reliability weight, the first reliability weight is calculated as a value between an intermediate value and an upper limit value for the difference between the acoustic feature and the non-acoustic feature, and the second reliability weight is calculated as a value acquired by subtracting the first reliability weight from the upper limit value.

4. The voice activity detection apparatus according to claim 3, wherein the processing circuit calculates the integrated feature using the first reliability weight and the second reliability weight.

5. The voice activity detection apparatus according to claim 1, wherein the non-acoustic signal is an image signal temporally synchronized with the acoustic signal.

6. The voice activity detection apparatus according to claim 1, wherein the processing circuit determines whether the non-acoustic signal is a normal signal or an abnormal signal, based on the reliability weight, and issues notification to display a determination result as to whether the non-acoustic signal is a normal signal and an abnormal signal.

7. A learning apparatus comprising a processing circuit, the processing circuit executing:
acquiring an acoustic signal and a non-acoustic signal relating to a same voice generation source;
calculating an acoustic feature from the acoustic signal using a first neural network;
calculating a non-acoustic feature from the non-acoustic signal using a second neural network;
calculating a reliability weight based on a difference between the acoustic feature and the non-acoustic feature;
calculating an integrated feature of the acoustic feature and the non-acoustic feature based on the reliability weight;
calculating a voice existence probability from the integrated feature using a third neural network; and
updating the first neural network, the second neural network, and the third neural network using a total loss function including a first loss function and a second loss function, the first loss function providing a penalty for a difference between the acoustic feature and the non-acoustic feature, and the second loss function providing a penalty for a difference between a correct label relating to a voice section and a non-voice section and the voice existence probability.

8. A non-transitory computer-readable storage medium including computer-executable instructions, wherein the instructions, when executed by a processor, cause the processor to perform operations comprising:
calculating an acoustic feature based on an acoustic signal;
calculating a non-acoustic feature based on a non-acoustic signal acquired from a same generation source as the acoustic signal;
calculating a reliability weight based on a difference between the acoustic signal and the non-acoustic signal;
calculating an integrated feature of the acoustic feature and the non-acoustic feature based on the reliability weight;
calculating a voice existence probability based on the integrated feature; and
detecting a voice section and/or a non-voice section based on comparison of the voice existence probability with a threshold, the voice section being a time section in which voice is presence, the non-voice section being a time section in which voice is absence.
